(19) United States
(12) Patent Application Publication
(10) Pub. No.: US 2025/0208825 A1
(43) Pub. Date: Jun. 26, 2025

(54) PROXIMITY BASED BROADCAST ONBOARDING FOR AUDIO DEVICES

(71) Applicant: QUALCOMM Incorporated, San Diego, CA (US)

(72) Inventors: Ravi SHEKHAR, Thubarahalli (IN); Shitiz KUMAR, Bangalore (IN); Sushil DEKA, Bangalore (IN); Chirag Manojkumar KHARVAR, Bangalore (IN); Sachin TOMAR, Ghaziabad (IN); Jagdeep Kumar HANS, Bangalore (IN)

(21) Appl. No.: 18/391,361

(22) Filed: Dec. 20, 2023

(51) Int. Cl. G06F 3/16; H04R 1/10

(52) U.S. Cl. CPC G06F 3/165; H04R 1/1041

(57) ABSTRACT

Disclosed are systems and techniques for wireless communications. For example, an audio device can receive, from an onboarding device associated with a broadcast device, one or more connection request signals requesting a connection with the audio device and comprising an address of the onboarding device. The audio device can output, for transmission to the onboarding device based on the address of the onboarding device, one or more first connection signals to establish a first connection with the onboarding device. The audio device can receive, from the onboarding device via the first connection with the onboarding device, one or more information signals comprising synchronization information associated with the broadcast device. The audio device can synchronize with the broadcast device using the synchronization information to receive one or more broadcast signals comprising broadcast information.

### FIELD

The present disclosure generally relates to wireless communications. For example, aspects of the present disclosure relate to proximity based broadcast onboarding for audio devices, such as earbuds and headsets.

### BACKGROUND

Multimedia systems are widely deployed to provide various types of multimedia communication content such as voice, video, packet data, messaging, broadcast, and so on. These multimedia systems may be capable of processing, storage, generation, manipulation, and rendition of multimedia information. Examples of multimedia systems include mobile devices, game devices, entertainment systems, information systems, virtual reality systems, model and simulation systems, and so on. These systems may employ a combination of hardware and software technologies to support the processing, storage, generation, manipulation, and rendition of multimedia information, for example, client devices, capture devices, storage devices, communication networks, computer systems, and display devices.

In some cases, portable devices, such as audio devices (e.g., earbuds, headsets, and head-mounted displays with ear pieces), can be used with a wide variety of multimedia systems. Wireless listening devices do not include a cable and instead, wirelessly receive a stream of audio data from a wireless audio source, have become popular and can be used in multimedia systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for proximity based broadcast onboarding for audio devices. According to at least one example, an audio device associated with a user is provided for wireless communications. The audio device includes at least one memory and at least one processor coupled to the at least one memory and configured to: receive, from an onboarding device associated with a broadcast device, one or more connection request signals requesting a connection with the audio device and comprising an address of the onboarding device; output, for transmission to the onboarding device based on the address of the onboarding device, one or more first connection signals to establish a first connection with the onboarding device; receive, from the onboarding device via the first connection with the onboarding device, one or more information signals comprising synchronization information associated with the broadcast device; and synchronize with the broadcast device using the synchronization information to receive one or more broadcast signals comprising broadcast information.

In another example, a method is provided for wireless communications at an audio device associated with a user. The method includes: receiving, by the audio device from an onboarding device associated with a broadcast device, one or more connection request signals requesting a connection with the audio device and comprising an address of the onboarding device; transmitting, by the audio device to the onboarding device based on the address of the onboarding device, one or more first connection signals to establish a first connection with the onboarding device; receiving, by the audio device from the onboarding device via the first connection with the onboarding device, one or more information signals comprising synchronization information associated with the broadcast device; and synchronizing, by the audio device, with the broadcast device using the synchronization information to receive one or more broadcast signals comprising broadcast information.

In another example, a non-transitory computer-readable medium of an audio device is provided having stored thereon instructions that, when executed by one or more processors, cause the one or more processors to: receive, from an onboarding device associated with a broadcast device, one or more connection request signals requesting a connection with the audio device and comprising an address of the onboarding device; output, for transmission to the onboarding device based on the address of the onboarding device, one or more first connection signals to establish a first connection with the onboarding device; receive, from the onboarding device via the first connection with the onboarding device, one or more information signals comprising synchronization information associated with the broadcast device; and synchronize with the broadcast device using the synchronization information to receive one or more broadcast signals comprising broadcast information.

In another example, an apparatus for wireless communications is provided. The apparatus includes: means for receiving, from an onboarding device associated with a broadcast device, one or more connection request signals requesting a connection with the apparatus and comprising an address of the onboarding device; means for transmitting, to the onboarding device based on the address of the onboarding device, one or more first connection signals to establish a first connection with the onboarding device; means for receiving, from the onboarding device via the first connection with the onboarding device, one or more information signals comprising synchronization information associated with the broadcast device; and means for synchronizing with the broadcast device using the synchronization information to receive one or more broadcast signals comprising broadcast information.

In another example, an onboarding device is provided for wireless communications. The onboarding device includes at least one memory and at least one processor coupled to the at least one memory and configured to: output, for transmission to an audio device associated with a user based on receiving an activation command requesting to receive one or more broadcast signals from a broadcast device associated with the onboarding device, one or more connection request signals requesting a connection with the audio device and comprising an address of the onboarding device; receive, from the audio device based on the address of the onboarding device, one or more connection signals to establish a connection with the audio device; output, based on receiving the one or more connection signals from the audio device, an indication that the audio device is attempting to connect with the onboarding device; receive a connection acceptance command to establish the connection with the audio device; and output, for transmission to the audio device via the connection with the audio device, one or more information signals comprising synchronization information associated with the broadcast device for the audio device to synchronize with the broadcast device to receive the one or more broadcast signals.

In another example, a method is provided for wireless communications at an onboarding device. The method includes: transmitting, by the onboarding device associated with a broadcast device to an audio device associated with a user based on receiving an activation command requesting to receive one or more broadcast signals from the broadcast device, one or more connection request signals requesting a connection with the audio device and comprising an address of the onboarding device; receiving, by the onboarding device from the audio device based on the address of the onboarding device, one or more connection signals to establish a connection with the audio device; outputting, by the onboarding device based on receiving the one or more connection signals from the audio device, an indication that the audio device is attempting to connect with the onboarding device; receiving, by the onboarding device, a connection acceptance command to establish the connection with the audio device; and transmitting, by the onboarding device to the audio device via the connection with the audio device, one or more information signals comprising synchronization information associated with the broadcast device for the audio device to synchronize with the broadcast device to receive the one or more broadcast signals.

In another example, a non-transitory computer-readable medium of an onboarding device is provided having stored thereon instructions that, when executed by one or more processors, cause the one or more processors to: output, for transmission to an audio device associated with a user based on receiving an activation command requesting to receive one or more broadcast signals from a broadcast device associated with the onboarding device, one or more connection request signals requesting a connection with the audio device and comprising an address of the onboarding device; receive, from the audio device based on the address of the onboarding device, one or more connection signals to establish a connection with the audio device; output, based on receiving the one or more connection signals from the audio device, an indication that the audio device is attempting to connect with the onboarding device; receive a connection acceptance command to establish the connection with the audio device; and output, for transmission to the audio device via the connection with the audio device, one or more information signals comprising synchronization information associated with the broadcast device for the audio device to synchronize with the broadcast device to receive the one or more broadcast signals.

In another example, an apparatus for wireless communications is provided. The apparatus includes: means for transmitting, to an audio device associated with a user based on receiving an activation command requesting to receive one or more broadcast signals from a broadcast device associated with the apparatus, one or more connection request signals requesting a connection with the audio device and comprising an address of the apparatus; means for receiving, from the audio device based on the address of the apparatus, one or more connection signals to establish a connection with the audio device; means for outputting, based on receiving the one or more connection signals from the audio device, an indication that the audio device is attempting to connect with the apparatus; means for receiving a connection acceptance command to establish the connection with the audio device; and means for transmitting, to the audio device via the connection with the audio device, one or more information signals comprising synchronization information associated with the broadcast device for the audio device to synchronize with the broadcast device to receive the one or more broadcast signals.

Aspects generally include a method, apparatus, system, computer program product, non-transitory computer-readable medium, user equipment, base station, wireless communication device, and/or processing system as substantially described herein with reference to and as illustrated by the drawings and specification.

In some aspects, each of the apparatuses described above is, can be part of, or can include an audio device, a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with some aspects of the present disclosure.

FIG. 2 illustrates an example wireless audio device in the form of earbuds, in accordance with some aspects of the present disclosure.

FIG. 3 illustrates a conceptual diagram of a wireless audio system that may be configured to use a single audio device, in accordance with some aspects of the present disclosure.

FIG. 4A is a perspective diagram illustrating a head-mounted display (HMD), in accordance with some aspects of the present disclosure.

FIG. 4B is a perspective diagram illustrating the HMD of FIG. 4A being worn by a user, in accordance with some aspects of the present disclosure.

FIG. 5 is a diagram illustrating an example of a process for proximity based broadcast onboarding for audio devices, in accordance with some aspects of the present disclosure.

FIG. 6 is a diagram illustrating an example of a system for proximity based broadcast onboarding for audio devices, where a user is activating onboarding with a broadcast device to receive broadcast signals, in accordance with some aspects of the present disclosure.

FIG. 7 is a diagram illustrating the system of FIG. 6 for proximity based broadcast onboarding for audio devices, where a connection is being established between an audio device associated with a user and an onboarding device, in accordance with some aspects of the present disclosure.

FIG. 8 is a diagram illustrating the system of FIG. 6 for proximity based broadcast onboarding for audio devices, where an audio device associated with a user is receiving from a connected onboarding device information associated with a broadcast device, in accordance with some aspects of the present disclosure.

FIG. 9 is a diagram illustrating the system of FIG. 6 for proximity based broadcast onboarding for audio devices, where an audio device associated with a user is receiving broadcast information from a connected broadcast device, in accordance with some aspects of the present disclosure.

FIG. 10A is a flow chart illustrating an example of a process for wireless communications, in accordance with some aspects of the present disclosure.

FIG. 10B is a flow chart illustrating another example of a process for wireless communications, in accordance with some aspects of the present disclosure.

FIG. 11 is a block diagram illustrating an example computing system, in accordance with some aspects of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Audio devices (e.g., such as earbuds, headsets, and head-mounted displays with attached earpieces) are becoming increasingly popular and are commonly owned among the general public. Typically, audio devices interact with a source device (e.g., a broadcast source device) to receive monophonic (mono) or stereophonic (stereo) audio, either directly from the broadcast source devices themselves or indirectly from the broadcast source devices via a relay(s). Almost all use cases (e.g., involving downloading music and/or making conversational calls) use services that involve a mobile device (e.g., smart phone) or a central device (e.g., a server) that operates as the origin of the service.

With the release of the Bluetooth low energy audio (LEA) specification by Bluetooth Special Interest Group (SIG), the broadcast audio feature (e.g., which basically enables an audio stream to be broadcasted to an unlimited number of audio sink devices) is expected to become widely used, and allows for new opportunities for innovation involving better user experience and introducing new setups and/or topology to accommodate existing use cases.

Public places throughout will likely see a significant rise in the number of broadcast sources, and there will likely soon become a need to be able to navigate through all of these available sources with ease and to be able to latch on to the desired sources as seamlessly as possible. The increase in the number of broadcast sources can lead to a number of various challenges. For example, the increase in the number of broadcast sources can make it difficult for a user to be able to securely choose a broadcast source of interest from the large volume of available broadcast sources, where some of which may be undesirable spoofer sources. For another example, the increase in the number of broadcast sources can lead to a drain in audio device power because the audio device would need to scan for multiple broadcast signals in their vicinity to be able to latch onto the desired broadcast source(s). These broadcast signals may be public broadcast signals or private broadcast signals. Private broadcast signals are generally encrypted and, as such, a user would need an encryption key to be able to decrypt the private broadcast signals to be able to listen to the audio.

Bluetooth LEA has brought certain roles where mobile devices (e.g., smart phones, which may operate in an initiator or a commander role) or remote control device (e.g., an onboarding device, which may operate in a commander role) can aid an audio device (e.g., earbuds) in scanning for a desired broadcast source. The audio device can be offloaded (e.g., to operate in an acceptor role) by the mobile device or the remote control device, when a user associated with the audio device chooses which broadcast source to listen to by selecting the broadcast source on a menu displayed on the mobile device or the remote control device. Since the mobile devices (e.g., smart phones) and audio devices (e.g., earbuds) have the potential to evolve at a different pace, it is very possible that in the marketplace, the LEA enabled audio devices (e.g., earbuds) and the other mobile devices (e.g., smart phones) are not upgraded similarly at the same rate to be able to support the latest of LEA features for quite some time.

For an example problem scenario for onboarding an audio device to a broadcast source, Bob walks into an airport with his latest earbuds that he has been told he can use to listen to any public broadcast for audio announcements. Bob pulls out his phone to see how he can choose the right broadcast to receive these audio announcements. To Bob's dismay, Bob may find that his phone is not yet ready to understand this technology (e.g., Bob's phone's operating system has not yet been upgraded for this technology). As such, Bob is not able to listen to the broadcast announcements available at the airport. In other cases, Bob's phone can scan for all these broadcast sources. As such, Bob's phone displays a large list of all the available public announcements (e.g., available broadcast sources) from the airport. Some of the listed broadcast sources may have similar sounding names, and may be attackers in disguise. Bob is now worried about which broadcasting source he should select to listen to for receiving his desired public announcements.

However, if Bob continues to proceed and sync into one of the broadcast sources, Bob may be prompted to key in some code (e.g., encryption key) if the broadcast is encrypted. In this case, Bob must then fetch the needed encryption key, for example via phone applications provided by various vendors or by scanning a quick response (QR) code. As such, Bob is not very comfortable choosing a broadcast source, even though Bob's earbuds are enabled for various useful features.

If Bob does choose a broadcast source successfully, Bob could be on a call (e.g., on the smart phone) and not miss any important announcements (e.g., including flight status or gate information) because the call will pause to allow for the announcements to be broadcasted to Bob. Similarly, if Bob does choose a broadcast source successfully, Bob could be listening to his favorite music (e.g. on the earbuds) and not miss any important announcements (e.g., including flight status or gate information) because the music will pause playing to allow for the announcements to be broadcasted to Bob. Though Bob's earbuds are capable of providing these useful announcements to Bob, Bob may be deprived of usage of this feature because the connection to a desired broadcast source may be too difficult and complicated for Bob to choose one.

As the broadcast audio feature becomes popular and starts getting adopted in places such as transportation hubs (e.g., airports, train stations, subway stations, and bus stations), businesses (e.g., restaurants, pubs, and retail stores), places of worship (e.g., churches), and educational institutions (e.g., museums, and schools), more and more consumers will likely switch to LEA-based supporting audio devices (e.g., earbuds) and mobile devices (e.g., smart phones). For an audio device to be able to latch onto a desired broadcast source, a user associated with the audio device will likely need to spend some time scanning multiple broadcast signals on the audio device and pressing multiple buttons on the audio device when the broadcast is encrypted. These required steps are very time consuming and cumbersome and, as such, can lead to a poor user experience. As such, an improved technique for broadcast onboarding for audio devices, such as earbuds, headsets, and head-mounted displays can be beneficial.

In some aspects of the present disclosure, systems, apparatuses, methods (also referred to as processes), and computer-readable media (collectively referred to herein as “systems and techniques”) are described herein for providing proximity based broadcast onboarding for audio devices (e.g., earbuds, headsets, and head-mounted displays with ear pieces). In one or more examples, the systems and techniques provide a solution that detects an audio device (e.g., earbuds) based on proximity through different supporting devices (e.g., an onboarding device) and provides a one-click experience to a user for synchronizing the audio device to a desired broadcast source (e.g., broadcast device).

In one or more aspects, the systems and techniques employ an onboarding device, which may be referred to as a broadcast onboarding device (BOD), to facilitate the onboarding of a broadcast source by an audio device with ease. The onboarding device may have a display that can display textual information regarding the different available broadcast sources. The onboarding device can have a proximity pairing button, which when triggered can scan for audio devices located within the vicinity of the onboarding device. The onboarding device can connect with an audio device and can assist the audio device in latching onto a desired broadcast source seamlessly via only one click (e.g., of a button) by the user. In some examples, the onboarding device (e.g., operating as a commander device) can discover encrypted keys that are needed for receiving the audio of an encrypted broadcast. In other examples, the onboarding device can be programmed with a predefined encryption key, which the onboarding device can pass onto the audio devices seamlessly upon connection with the audio device.

In some aspects, the systems and techniques allow for an audio device to be enabled for proximity-based pairing with an onboarding device (e.g., without bonding, meaning without storing the pairing information for the onboarding device) by a simple user action of pressing a button on an audio device (e.g., or making a gesture with the audio device) when the audio device is located near the onboarding device. Currently, there may be cases where in public places, when a user presses the button on (e.g., or makes a gesture with) an audio device for broadcast onboarding (e.g., for enabling the audio device to scan for non-connectable advertisements from the onboarding device to establish a connection with the onboarding device), the audio device may erroneously get connected/paired with other nearby devices that the user does not desire to be connected to. The user may need to press the button again on the audio device to again attempt broadcast onboarding with the onboarding device, and the user will need to delete the unnecessary bond information (e.g., pairing information) with the nearby device that the audio device had erroneously connected (e.g., paired) with. Audio devices in the market currently, generally, will hold pairing information of up to eight devices. As such, post pairing with a device, the user will need to selectively remove the pairing information of that device from the audio device. As the broadcast audio features gets adopted more and more, there can be increased chances of where pairing information of many onboarding devices and/or unwanted devices may get stored onto an audio device such that the audio device storage may reach the maximum number of devices for storing pairing information.

In one or more aspects, the systems and techniques provide that, along with proximity pairing, an audio device will not store bond information (e.g., pairing information) related to the pairing with an onboarding device, and will not deterministically be able to connect to an undesirable remote device. The audio device is able to place the address (e.g., Bluetooth address) of the onboarding device on a list (e.g., a whitelist) that includes a listing of addresses (e.g., Bluetooth addresses) of approved (e.g., desirable) devices for establishing a connection with the audio device. The use of the white list helps the audio device avoid connecting to unwanted nearby devices. If the audio device is near-field communication (NFC) enabled, the audio device may obtain the address of the onboarding device and the address of desired broadcast device the out-of-band (e.g., out of LEA). In one or more examples, audio device does not need to scan for the broadcast source device. The audio device uses the onboarding device to establish a connection with the broadcast device. The systems and techniques allow for a deterministic and secure onboarding of the audio device to the broadcast device.

In one or more aspects, the disclosed proximity-based broadcast onboarding can be utilized at silent airports by airlines for gate announcements. An airlines kiosk desk can have an onboarding device implemented within it, and the kiosk can inform passengers (e.g., users) about gate announcements for flights when users visit the kiosk to collect their boarding passes. With a simple tap on a button on an audio device (e.g., earbuds), a user may be able to obtain complete broadcast information regarding their flight, and may be able to have their audio device latch onto the broadcast device seamlessly to receive upcoming broadcasts.

In one or more examples, proximity-based broadcast onboarding may also be useful in parties where a user can join the party-related broadcasts by moving within close range to an onboarding device. The party organizer can triggers a proximity button on the onboarding device for the audio device associated with the user to be able to latch onto the onboarding device. In some examples, proximity-based broadcast onboarding may also be useful in museum tours, churches, pubs, restaurants, schools, etc. where a user may approach an onboarding device and press a button the audio device to onboard seamlessly with a desired broadcast devices to receive broadcasts. In one or more examples, proximity-based broadcast onboarding can also employ the use of charging cases (e.g., smart phone charging cases), which are currently becoming more intelligent by the addition of Bluetooth LEA and a display. A charging case can be utilized as both a commander and as a scanner to onboard an audio device in the vicinity with a broadcast device. In some examples, proximity-based broadcast onboarding can be extended to hearing aid devices, where a user can just (e.g., without the need of their phone) press a button on the audio device (e.g., hearing aid) to latch onto broadcast device when the user is located near an onboarding device with proximity pairing enabled. In one or more examples, proximity-based broadcast onboarding may also be useful in railway stations for receiving departure announcements.

In one or more aspects, the systems and techniques employ the use of a mobile device or a charging device for proximity-based broadcast onboarding of an audio device. In one or more examples, if a user wants to be aware of available broadcast onboarding, an optional low energy (LE) generic attribute profile (GATT) service can be implemented on the audio device, which will notify mobile device or charging device (e.g., which can have a client role for the LE GATT service) about the presence of a nearby onboarding device (e.g., kiosk), about the type of broadcasts available, and when a broadcast source is synchronized with the audio device.

In one or more aspects, the proximity-based broadcast onboarding can allow for an audio device to connect to an onboarding device more securely and deterministically, the audio device to not accumulate pairing information, the audio device to no longer need a mobile phone to connect to a broadcast source, the audio device to be useful in many different scenarios, and the audio device to share its role with a mobile device or charger case.

In one or more aspects, during operation of the systems and techniques, an audio device (e.g., associated with a user) can receive from an onboarding device (e.g., associated with a broadcast device) one or more connection request signals requesting a connection with the audio device and including an address of the onboarding device. The audio device can transmit to the onboarding device, based on the address of the onboarding device, one or more first connection signals to establish a first connection with the onboarding device. The audio device can receive from the onboarding device (e.g., via the first connection with the onboarding device) one or more information signals including an address of the broadcast source. The audio device can transmit to the broadcast device, based on the address of the broadcast source, one or more second connection signals to establish a second connection with the broadcast source. The audio device can receive from the broadcast device (e.g., via the second connection with the broadcast device) one or more broadcast signals including broadcast information.

In one or more examples, the audio device can receive from the user a scanning enabling command via the user pressing a button on the audio device or the user making a selection via a mobile device (e.g., providing user input via a display of the mobile device) associated with the user and in connection with the audio device. The audio device can scan for the one or more connection request signals, based on the audio device receiving the scanning enabling command from the user. In some examples, the audio device can store the address of the onboarding device in a list including a listing of approved devices for establishing a connection with the audio device. In one or more examples, the audio device can receive from the onboarding device (e.g., via the first connection) one or more encryption information signals including an encryption key for decrypting the one or more broadcast signals from the broadcast source. In some examples, the audio device can disconnect the first connection with the onboarding device.

In one or more examples, the address of the onboarding device and the address of the broadcast source are each a Bluetooth address. In some examples, the one or more connection request signals are non-connectable advertisements. In one or more examples, the broadcast information includes flight information, business related information, tour information, and/or instructional information. In some examples, the audio device is earbuds, an audio headset, or a head-mounted display (HMD).

In one or more aspects, during operation of the systems and techniques, an onboarding device (e.g., associated with a broadcast device) can transmit to an audio device (e.g., associated with a user), based on receiving an activation command from the user requesting to receive one or more broadcast signals from the broadcast source, one or more connection request signals requesting a connection with the audio device and including an address of the onboarding device. The onboarding device can receive from the audio device, based on the address of the onboarding device, one or more connection signals to establish a connection with the audio device. The onboarding device can indicate to the user, based on receiving the one or more connection signals from the audio device, the audio device is attempting to connect with the onboarding device. The onboarding device can receive from the user a connection acceptance command to establish the connection with the audio device. The onboarding device can transmit to the audio device (e.g., via the first connection with the audio device) one or more information signals including an address of the broadcast source for the audio device to establish a second connection with the broadcast source to receive the one or more broadcast signals.

In one or more examples, the onboarding device can receive from the user the activation command based on user input via the onboarding device (e.g., the user making a selection on a display of the onboarding device). In some examples, the onboarding device can receive the connection acceptance command based on user input via the onboarding device, the audio device, and/or a mobile device (e.g., the user making a selection on the display of the onboarding device, the user pressing a button on the audio device, the user making a selection on a display of a mobile device associated with the user and in connection with the audio device, any combination thereof, and/or other input). In one or more examples, the onboarding device can transmit to the audio device (e.g., via the first connection with the audio device) one or more encryption information signals including an encryption key for decrypting the one or more broadcast signals from the broadcast source.

Additional aspects of the present disclosure are described in more detail below.

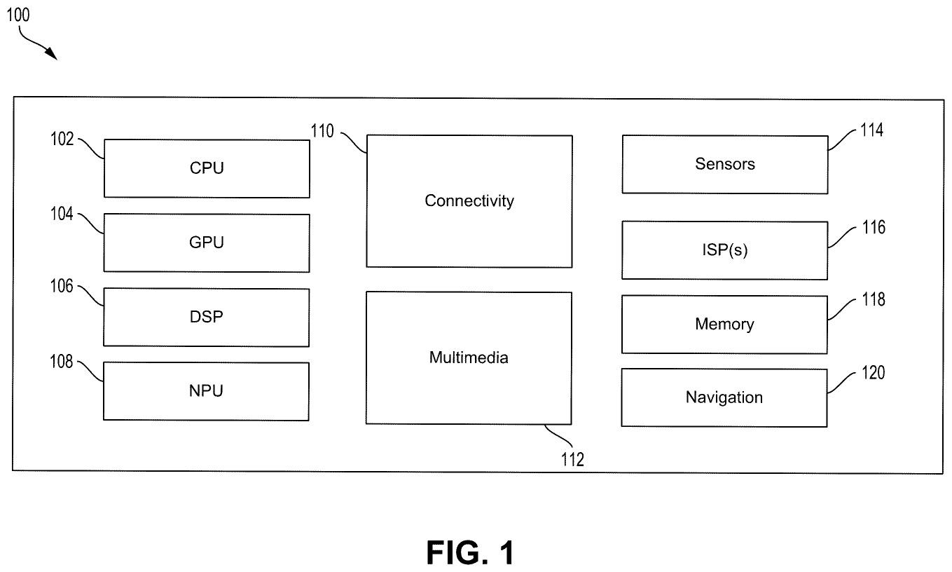

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118. In some cases, the SOC 100 may be based on an ARM instruction set.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia block 112 that may, for example, process and/or decode audio data. In some cases, the connectivity block 110 may provide multiple connections to various networks. For example, the connectivity block 110 may provide a connection to the Internet, via the 5G connection, as well as a connection to a personal device, such as a wireless headset, via the Bluetooth connection. In some cases, the multimedia block 112 may process multimedia data for transmission via the connectivity block 110. For example, the multimedia block 112 may receive an audio bitstream, for example, via the connectivity block 110 and multimedia block 112 encode (e.g., transcode, re-encode) the audio bitstream to an audio format supported by a wireless headset that is connected via the connectivity block 110. The encoded audio bitstream may then be transmitted to the wireless headset via the connectivity block 110.

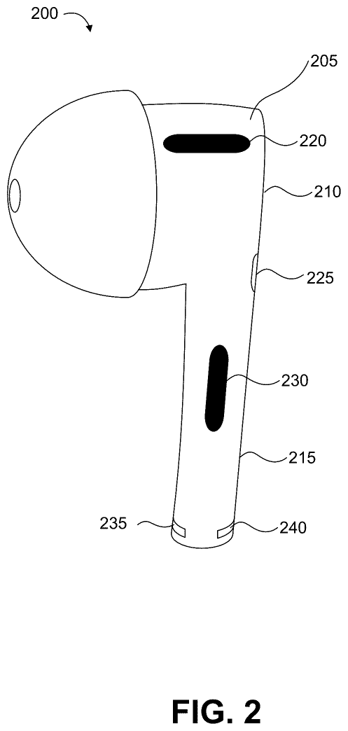

FIG. 2 illustrates an example wireless audio device 200 in the form of an earbud. The wireless audio device 200 provides a single channel of audio, either a left channel or a right channel, and can be operated with another wireless audio device (not shown) to provide two channels of audio (e.g., a left channel and a right channel). Each

According to some embodiments, each wireless audio device 200 can include a housing 205 formed of a body 210 and a stem 215 extending from body 210. In some aspects, the housing 205 can be formed of a monolithic outer structure such as a molded plastic. The body 210 can include an internally facing microphone 220 and an externally facing microphone 225. Externally facing microphone 225 can be positioned within an opening defined by portions of body 210 and stem 215. By extending into both body 210 and stem 215, microphone 225 can be large enough to receive sounds from a broader area proximate to the listener. In some embodiments, the housing 205 can define an acoustic port that can direct sound from an internal audio driver out of housing 205 and into a listener's ear canal. In other embodiments, wireless audio device 200 can include a deformable ear tip that can be inserted into a listener's ear canal enabling the wireless listening devices to be configured as in-ear hearing devices.

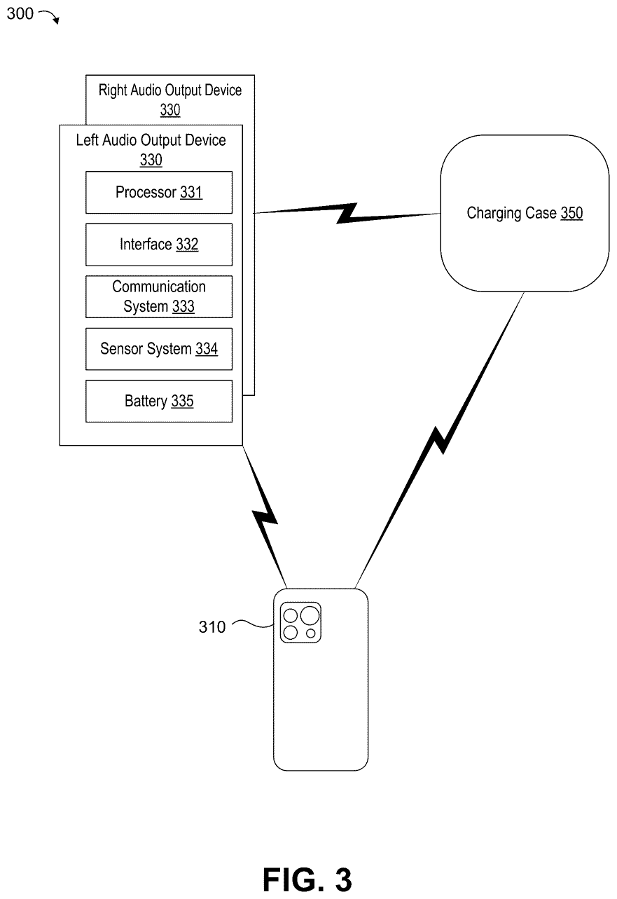

In one example, the stem 215 has a substantially cylindrical construction along with a planar region 230 that does not follow the curvature of the cylindrical construction. The planar region 230 can indicate an area where the wireless listening device is capable of receiving listener input. For instance, in some embodiments listener input can be inputted by squeezing stem 215 at planar region 230. In some embodiments, planar region 230 can include a touch-sensitive surface in addition to or instead of pressure sensing capabilities, that allow a listener to input touch commands, such as contact gestures. Stem 215 can also include electrical contact 235 and electrical contact 240 for contacting with corresponding electrical contacts in the charging case (e.g., charging case 350 in FIG. 3).

The wireless audio device 200 can include several features that can enable the devices to be comfortably worn by a listener for extended periods of time and even all day. The housing 205 can be shaped and sized to fit securely between the tragus and anti-tragus of a listener's ear so that the portable listening device is not prone to falling out of the ear even when a listener is exercising or otherwise actively moving. Its functionality can also enable wireless audio device 200 to provide an audio interface to the host device (e.g., host device 310 of FIG. 3) so that the listener may not need to utilize a graphical interface of the host device. The audio device 200 can be sufficiently sophisticated to enable the listener to perform day-to-day operations from the host device solely through interactions with a wireless audio device 200. This can create further independence from the host device by not requiring the listener to physically interact with, and/or look at the display screen of, the host device, especially when the functionality of wireless audio device 200 is combined with the voice control capabilities of the host device. Thus, wireless audio device 200 can enable a wireless and a hands-free experience for the listener.

The wireless audio device 200 can also include various components that cannot be visually perceived. For example, the wireless audio device 200 can include at least one sensor for detecting various aspects of the device. Illustrative aspects of the device include, the state of the device (e.g., whether the wireless audio device 200 is attached to a person), pose information related to a listener, biometric information (e.g., the temperature of the listener), and so forth. At least one of the sensors of the wireless audio device 200 can be configured to output pose information that identifies an orientation of the listener's head with respect to a neutral position (e.g., a neutral head position). The pose information may be used by a host device and the host device may be configured to alter an audio stream presented to the wireless audio device 200 to provide a spatial audio stream that provides a 3D virtual auditory space.

FIG. 3 illustrates a conceptual diagram of a wireless audio system 300 that may be configured to use a single audio device according to various aspects of the disclosure. The wireless audio system 300 includes a host device 310, a pair of audio devices 330 (e.g., a left audio device 330 and a right audio device 330, which may each be in the form of an earbud), and a charging case 350.

The host device 310 is depicted in FIG. 3 as a mobile communication device (e.g., a smartphone), but can be any electronic device that can transmit audio data to a wireless audio device (e.g., the wireless audio device 300 of FIG. 2). Other, non-limiting examples of suitable host devices 310 include a laptop computer, a desktop computer, a tablet computer, a smartwatch, an audio system, a video player, and the like.

In some aspects, each audio device 330 can receive and generate sound to provide an enhanced user interface for the host device 310. The audio device 330 can include a processor 331 that executes computer-readable instructions stored in a memory (not shown) for performing a plurality of functions for the audio device 330. In some examples, the processor 331 can be one or more suitable computing devices, such as microprocessors, computer processing units (CPUs), digital signal processing units (DSPs), field programmable gate arrays (FPGAs), application-specific integrated circuits (ASICs) and the like.

The processor 331 can be operatively coupled to an interface 332, a communication system 333, and a sensor system 334 for the audio device 330 to perform one or more functions. For instance, the interface 332 can include a driver (e.g., speaker) for outputting sound to a user, one or more microphones for inputting sound from the environment or the user, one or more light emitting diodes (LEDs) for providing visual notifications to a user, a pressure sensor or a touch sensor (e.g., a resistive or capacitive touch sensor) for receiving user input, and/or any other suitable input or output device. The communication system 333 can include wireless and wired communication components for enabling the audio device 330 to send and receive data/commands from the host device 310. For example, the communication system 333 can include circuitry that the audio device 330 to communicate with host device 310 over wireless link 360, which be implemented by a standard (e.g., Bluetooth, Wi-Fi Direct, Zigbee, etc.) or a proprietary communication link. The communication system 333 can also enable the audio device 330 to wirelessly communicate with the charging case 350 via a wireless link.

In some aspects, the sensor system 334 can include proximity sensors (e.g., optical sensors, capacitive sensors, radar, etc.), accelerometers, microphones, and any other type of sensor that can measure a parameter of an external entity and/or environment.

The audio device 330 may also include a battery 335, (e.g., a suitable energy storage device such as a lithium ion battery, etc.) that is capable of storing energy and discharging stored energy to operate the audio device 330. The discharged energy can be used to power the electrical components of audio device 330. The battery 335 can be a rechargeable battery and permit charging as needed to replenish stored energy. For instance, the battery 338 can be coupled to battery charging circuitry (not shown) that is operatively coupled to receive power from a charging case interface (not shown). The case interface may include electrical contacts to electrically couple with the audio device 330 to the charging case 350. In some aspects, power can be received by the audio device 330 from charging case 350 via the electrical contacts within the charging case. In some aspects, the audio device 330 may be changed via an inductive communication interface via a wireless power receiving coil within the charging case 350.

The charging case 350 can include a battery (not shown) that can store and discharge energy to power circuitry to recharge the battery 335 of the audio device 330. As mentioned above, the audio device 330 may include electrical contacts (e.g., electrical contact 235 and electrical contact 240 of FIG. 2) that can transfer power to the audio device 330 through a wired electrical connection between contacts in the charging case. In some cases, the charging case 350 may be configured to facilitate a setup of a wireless connection between the host device 310 and the audio device 330.

The charging case 350 can also include a processor (not shown) and a communication system (not shown). The processor can be one or more processors, ASICs, FPGAs, microprocessors, and the like for operating the charging case 350. The processor can be coupled to an earbud interface and can control the charging function of the charging case 350 to recharge batteries 335 of the audio device 330, and the processor can also be coupled to a communication system for operating the interactive functionalities of the charging case with other devices, including the audio device 330. In one example, the communication system of the charging case 350 includes a Bluetooth component, or any other suitable wireless communication component, that wirelessly sends and receives data with the communication system 333 of the audio device 330. Towards this end, the charging case 350 and each audio device 330 can include an antenna formed of a conductive body to send and receive electromagnetic signals.

The charging case 350 can also include a user interface (e.g., a button, a speaker, a light emitter such as an LED, etc.) that can be operatively coupled to the processor to alert a user of various notifications. For example, the user interface can include a speaker that can emit audible noise capable of being heard by a user and/or one or more LEDs or similar lights that can emit a light that can be seen by a user. For example, the charging case 350 may output audio or light to indicate whether at least one audio device 330 is being charged by charging case 350 or to indicate whether the case battery is low on energy or being charged.

The host device 310 is configured to connect to the audio device 330 and provide audio information. The audio device 330 may also provide information in some contexts, such as whether the audio device 330 is attached to a listener. In some cases, the host device 310 can include a processor (not shown) that is coupled to a battery (not shown) and a host memory bank (not shown) containing lines of code executable by the host computing system (not shown) for operating the host device 310. The host device 310 can also include a host sensor system, e.g., accelerometer, gyroscope, light sensor, and the like, for allowing host device 310 to sense the environment, and a host user interface system, e.g., display, speaker, buttons, touch screen, and the like, for outputting information to and receiving input from a user. Additionally, the host device 310 can also include a communication system for allowing host device 310 to send and/or receive data, e.g., wireless fidelity (Wi-Fi), long term evolution (LTE), code division multiple access (CDMA), global system for mobiles (GSM), Bluetooth, and the like. The communication system of the host device 310 can also communicate with the communication system 333 via a wireless communication link so that the host device 310 can send audio data to the audio device 330 to output sound, and receive data from the audio device 330 to receive user inputs. The communication link can be any suitable wireless communication line such as Bluetooth connection. By enabling communication between the host device 310 and the audio device 330, the audio device 330 can enhance the user interface of host device 310.

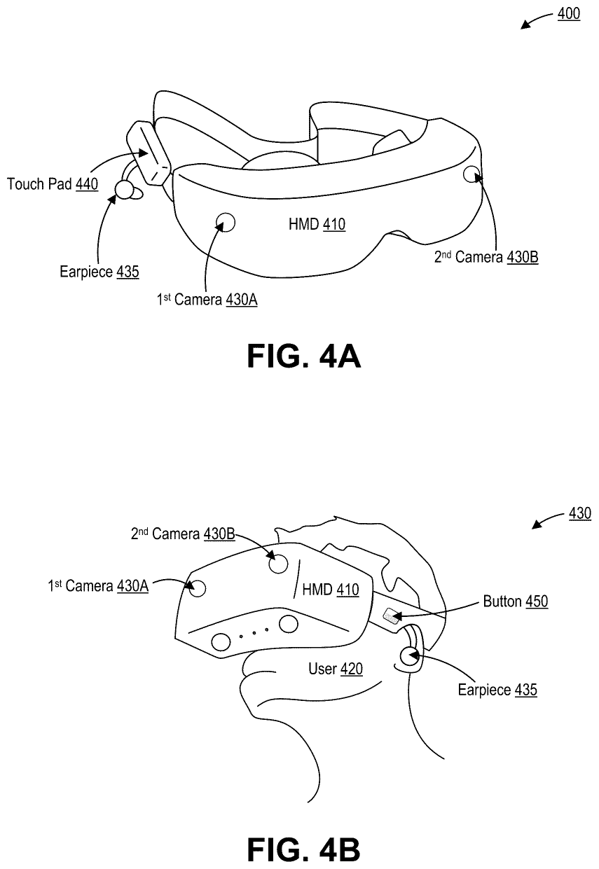

FIG. 4A is a perspective diagram 400 illustrating a head-mounted display (HMD) 410, configured for audio playback delay optimization in accordance with some examples. The HMD 410 may be, for example, an augmented reality (AR) headset, a virtual reality (VR) headset, a mixed reality (MR) headset, an extended reality (XR) headset, or some combination thereof. In some cases, HMD 410 may be an example of the user device 302. In some cases, HMD 410 may be coupled to the user device 302 via a wireless or wired connection for example, via connectivity component 304. The HMD 410 may include a first camera 430A and a second camera 430B along a front portion of the HMD 410. The first camera 430A and the second camera 430B may be two environment facing image sensors of the one or more image sensors 202 of FIG. 2. In some examples, the HMD 410 may only have a single camera. In some examples, the HMD 410 may include one or more additional cameras in addition to the first camera 430A and the second camera 430B.

The HMD 410 may include one or more earpieces 435, which may function as speakers and/or headphones that output audio to one or more ears of a user of the user device 302, and may be examples of wireless audio device 312. One earpiece 435 is illustrated in FIGS. 4A and 4B, but it should be understood that the HMD 410 can include two earpieces, with one earpiece for each ear (left ear and right ear) of the user. In some examples, the HMD 410 can also include one or more microphones (not pictured). In some examples, the audio output by the HMD 410 to the user through the one or more earpieces 435 may include, or be based on, audio recorded using the one or more microphones.

In one or more examples, a user 420 may use touch gestures to control operations (e.g., to perform control options) of the HMD 410 (e.g., XR device). The user 420 may perform a touch gesture by touching the touch pad 440 with a hand (e.g., via one or more fingers of the hand) of the user 420. In one or more examples, the touch gestures may include, but are not limited to, a single tap operation (e.g., where the user 420 taps the touch pad 440 with a single finger once), a double tap operation (e.g., where the user 420 taps the touch pad 440 with a single finger twice), a press and hold operation (e.g., where the user 420 touches the touch pad 440 and holds the touch to the touch pad 440 for a duration of time with a single finger), a swipe forward operation (e.g., where the user 420 swipes the touch pad, with a single finger, in a forward direction, from the back of the head of the user towards the face of the user), and/or a swipe backward operation (e.g., where the user 420 swipes the touch pad, with a single finger, in a backward direction, from the face of the user towards the back of the head of the user). In one or more examples, the control options (e.g., operations) may include, but are not limited to, a pause operation (e.g., to pause a video and/or audio being played by the HMD 410), a select operation (e.g., to select an option being presented by the HMD 410 to the user 420), a next operation (e.g., to move to another screen or another object being presented by the HMD 410 to the user 420), a voice assist operation (e.g., to invoke voice assistance by the HMD 410 for the user 420), a volume up operation (e.g., to increase the volume in audio controlled by the HMD 410), and/or a volume down operation (e.g., to decrease the volume in the audio controlled by the HMD 410).

FIG. 4B is a perspective diagram 430 illustrating the head-mounted display (HMD) 410 of FIG. 4A being worn by a user 420, in accordance with some examples. The user 420 wears the HMD 410 on the user 420's head over the user 420's eyes. The HMD 410 can capture images with the first camera 430A and the second camera 430B. In some examples, the HMD 410 displays one or more display images toward the user 420's eyes that are based on the images captured by the first camera 430A and the second camera 430B. The display images may provide a stereoscopic view of the environment, in some cases with information overlaid and/or with other modifications. For example, the HMD 410 can display a first display image to the user 420's right eye, the first display image based on an image captured by the first camera 430A. The HMD 410 can display a second display image to the user 420's left eye, the second display image based on an image captured by the second camera 430B. For instance, the HMD 410 may provide overlaid information in the display images overlaid over the images captured by the first camera 430A and the second camera 430B. An earpiece 435 of the HMD 410 is illustrated in an ear of the user 420. The HMD 410 may be outputting audio to the user 420 through the earpiece 435 and/or through another earpiece (not pictured) of the HMD 410 that is in the other ear (not pictured) of the user 420.

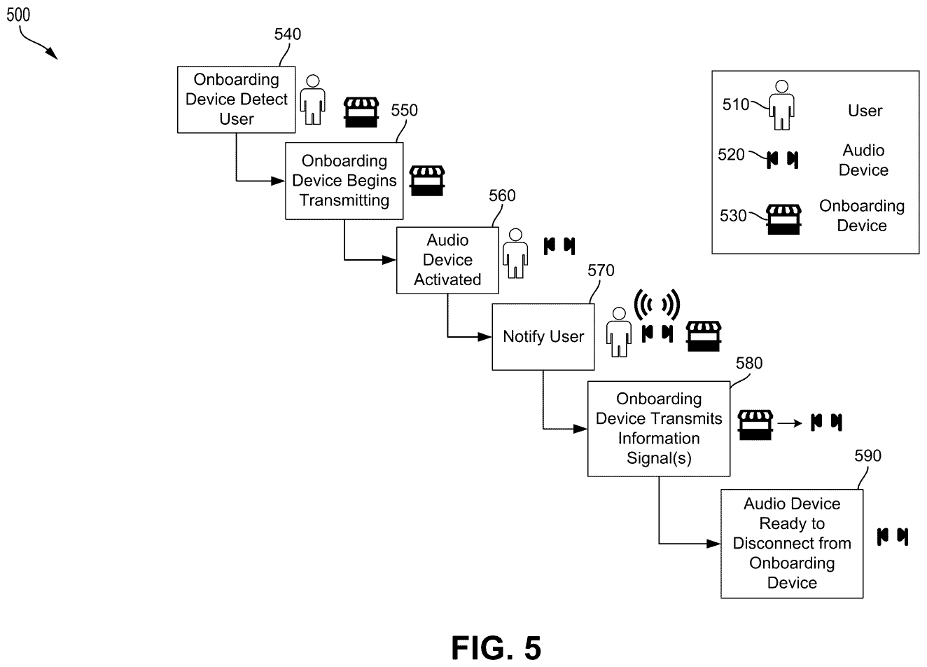

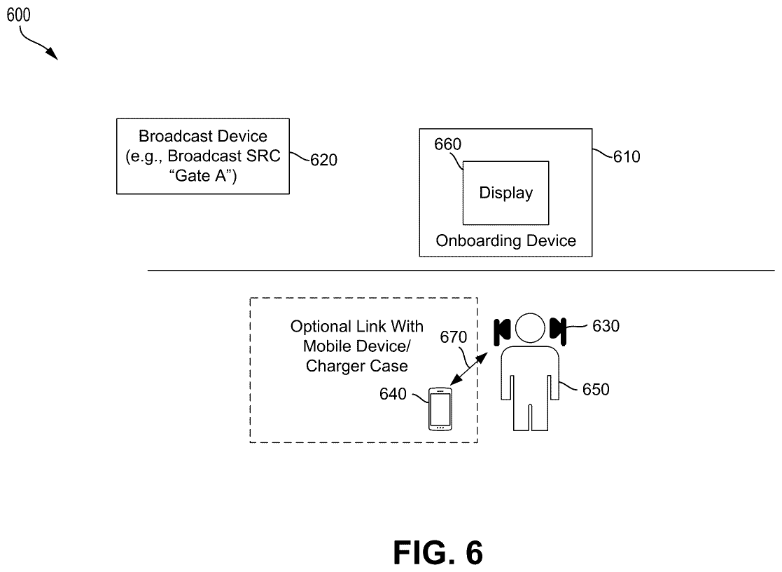

In some examples, a user 520 may use a button 450 on the HMD 410 to control operations. In one or more examples, the user 520 may press the button 450 on the HMD 410 to enable the HMD 410 to scan to receive one or more connection request signals (e.g., non-connectable advertisements) transmitted from an onboarding device (e.g., onboarding device 530 of FIG. 5 and/or onboarding device 610 of FIGS. 6, 7, 8, and 9). In some examples, the user 520 may press the button 450 on the HMD 410 to accept the establishment of a connection between the HMD 410 and an onboarding device (e.g., onboarding device 530 of FIG. 5 and/or onboarding device 610 of FIGS. 6, 7, 8, and 9).

As previously mentioned, the systems and techniques provide proximity based broadcast onboarding for audio devices, such as earbuds (e.g., wireless audio device 200 of FIG. 2), headsets, and head-mounted displays with ear pieces (e.g., HMD 410 of FIGS. 4A and 4B). In one or more examples, the systems and techniques provide a solution that detects an audio device (e.g., earbuds) based on proximity through different supporting devices (e.g., an onboarding device) and provides a one-click experience to a user for synchronizing the audio device to a desired broadcast source (e.g., broadcast device).

In one or more aspects, the systems and techniques provide a mechanism for detecting audio devices based on proximity through different supporting devices (e.g., an onboarding device, which may be in the form of a kiosk), and allowing a user a one-click experience for synchronizing to the desired broadcast device. The systems and techniques eliminate need for a mobile device (e.g., smart phone) to achieve the basic onboarding functionality.

FIG. 5 is a diagram illustrating an example of a process 500 for proximity based broadcast onboarding for audio devices. In FIG. 5, an audio device 520 (e.g., in the form of earbuds), a user 510, and an onboarding device 530, such as a BOD, (e.g., in the form of a kiosk) are shown. In one or more examples, the audio device 520 may be of different forms (e.g., an audio headset, an HMD, AR/VR glasses, a hearing aid, or other device) than the form (e.g., earbuds) as is shown in FIG. 5. In some examples, the onboarding device 530 may be of different forms (e.g., a desk) than the form (e.g., a kiosk) as is shown in FIG. 5.

In one or more examples, a broadcast device (e.g., broadcast device 620 of FIG. 6) may have transmitters that can transmit audio channels on certain published channel specifications. In order to listen to these audio channels, the audio device 520 will need to go through a procedure (e.g., a synchronization procedure) to be able to latch onto (e.g., to synchronize with) the desired broadcast device to receive the desired broadcast signals. The onboarding device 530 can operate as a commander device. For example, the the onboarding device 530 can enable the audio device 520 to synchronize with a desired broadcast device. The onboarding device 530 can obtain the information needed for the audio device 520 to be able to latch onto the appropriate audio channels, and can forward obtained information to the audio device 520.

During operation of the process 500 for proximity based broadcast onboarding for audio devices, at block 540, the user 510 may arrive at the onboarding device 530 (e.g., a BOD) and, as such, the onboarding device 530 may detect or determine that the user 510 (or the audio device 520 in some cases) is located in close proximity to the onboarding device 530. For instance, the user 510 can activate onboarding with a broadcasting device by providing user input via the onboarding device 530, such as by making a selection on a display (e.g., a touch screen) of the onboarding device 530 (e.g., to send an activation command from the user 510 to the onboarding device 530). In one or more examples, the display may be a touch screen, and the user 510 can make the selection by touching the touch screen.

Upon detecting or determining the user 510 (or audio device 520) is located in close proximity to the onboarding device 530 (e.g., after the user 510 makes the selection on the display of the onboarding device 530), at block 550, the onboarding device 530 can start to transmit (e.g., via a low energy audio (LEA) link) one or more connection request signals (e.g., connection beacons), which may be in the form of non-connectable advertisements, towards the user 510. The one or more connection request signals may include an address (e.g., a Bluetooth address) for the onboarding device 530. The onboarding device 530 can then start to scan to receive one or more connection signals (e.g., first connection signals) from an audio device 520 associated with the user 510.

At block 560, the audio device 520 can be activated. For example, the user 510 can enable the audio device 520 to scan to receive the one or more connection request signals from the onboarding device 530. In one or more examples, the user 510 can enable the audio device 520 to scan by providing input to the audio device, such as by pressing a button (e.g., a dedicated button, such as button 450 of FIG. 4B) on the audio device 520. In one or more examples, the user 510 can enable the audio device 520 to scan by providing user input (e.g., making a selection) to a mobile device (e.g., via a display of the mobile device) associated with the user 510 that is in communication (e.g., via a BLE link) with the audio device 520. In one or more examples, when the user 510 provides input to the audio device 520 (e.g., presses the button) or to the mobile device (e.g., makes a selection via the display of the mobile device), a scanning enabling command can be sent (e.g., transmitted) to the audio device 520. The mobile device can include a mobile phone, a wearable device, an XR device, or other type of device.

After the user 510 enables the audio device 520 to scan, the audio device 520 can start to scan for (e.g., to receive) the one or more connection requests from the onboarding device 530 (e.g., based on receiving the scanning enabling command). The audio device 520 can then receive (e.g., via an LEA link) the one or more connection request signals from the onboarding device 530. After the audio device 520 receives the one or more connection request signals (e.g., including the address of the onboarding device), the audio device 520 can stop the scanning.

After the audio device 520 stops scanning, the audio device 520 can include the address of the onboarding device 530 to a list (e.g., a whitelist) stored on the audio device 520 that includes addresses of devices that the audio device 520 may connect with. The audio device 520 may then transmit (e.g., via an LEA link) one or more connection signals (e.g., first connection signals) directed to the address of the onboarding device 530 to establish a connection with the onboarding device 530. The onboarding device 530 can then receive (e.g., via an LEA link) the one or more connection signals from the audio device 520.

After the onboarding device 530 receives the one or more connection signals from the audio device 520, at block 570, the onboarding device 530 can indicate (e.g., via the display of the onboarding device 530) to the user 510 that the audio device 520 is attempting to connect with the onboarding device 530. The user 510 can accept the connection with the onboarding device 530 by providing input to onboarding device 530, such as by making a selection on the display (e.g., a touch screen) of the onboarding device 530.

In one or more examples, the audio device 520 can indicate (e.g., via audio, either textual or sounds) to the user 510 that the audio device 520 is attempting to connect with the onboarding device 530. The user 510 can accept the connection with the onboarding device 530 by pressing a button (e.g., a dedicated button) on the audio device 520.

In some examples, a mobile device (e.g., a mobile phone or a charging device) associated with the user 510 that is in communication (e.g., via a BLE link) with the audio device 520 can indicate (e.g., via the display of the mobile device) to the user 510 that the audio device 520 is attempting to connect with the onboarding device 530. The user 510 can accept the connection with the onboarding device 530 by providing input to mobile device, such as by making a selection on the display (e.g., touch screen) of the mobile device (e.g., to send a connection acceptance command from the user 510 to the onboarding device 530).

After the onboarding device 530 receives the acceptance from the user 510 (e.g., via the onboarding device 530, the audio device 520, and/or the mobile device) for the connection, the connection can be established between the audio device 520 and the onboarding device 530.

After the connection is established between the audio device 520 and the onboarding device 530, at block 580, the onboarding device 530 can transmit (e.g., via an LEA link) one or more information signals to the audio device 530. The one or more information signals can include information associated with the broadcast source. The information can include an address (e.g., Bluetooth address) for the broadcast source. Optionally, the onboarding device 530 can transmit (e.g., via an LEA link) one or more encryption information signals to the audio device 510. The one or more encryption information signals can include an encryption key for the audio device 520 to use to decrypt signals received from the broadcast source.

After the audio device 520 receives the one or more information signals from the onboarding device 530, at block 590, the audio device 520 can disconnect from the onboarding device 530. After the audio device 520 disconnects from the onboarding device 530, the audio device 520 can transmit, based on the information (e.g., address of the broadcast device), one or more connection signals (e.g., second connection signals) to the broadcast device to establish a connection with (e.g., latch onto) the broadcast source 530. After the audio device 520 establishes a connection with the broadcast source 530, the audio device 520 can receive one or more broadcast signals (e.g., including flight information, business related information, tour information, and/or instructional information) from the broadcast source.

FIGS. 6, 7, 8, and 9 together illustrate a system 600 performing proximity based broadcast onboarding for audio devices. In particular, FIG. 6 is a diagram illustrating an example of a system 600 for proximity based broadcast onboarding for audio devices, where a user 650 is activating onboarding with a broadcast device 620 to receive broadcast signals. In FIG. 6, the system 600 is shown to include a broadcast device 620, an audio device 630 in the form of a headset, a user 650 (e.g., passenger), a mobile device 640 (e.g., in the form of a smart phone) and an onboarding device 610 (e.g., a BOD) in the form of a kiosk (e.g., including a display 660) are shown. In one or more examples, the audio device 630 can be of different forms (e.g., earbuds, an HMD, or a hearing aid) than the form (e.g., audio headset) as is shown in FIG. 6. In some examples, the onboarding device 610 may be of different forms (e.g., a desk) than the form (e.g., a kiosk) as is shown in FIG. 6. In some examples, the mobile device 640 may be of different forms (e.g., a charging device) than the form (e.g., a smart phone) as is shown in FIG. 6. In one or more examples, the mobile device 640 can be in connection (e.g., via a BLE link 670) with the audio device 630.

During operation of the process for proximity based broadcast onboarding for audio devices, the user 650 may arrive at the onboarding device 610 and, as such, the user 650 is located in close proximity to the onboarding device 610. The user 650 may type on the display 660 (e.g., a touch screen) of the onboarding device 610 the user's 650 passenger name record (PNR). Alternatively, the user 650 may show the user's 650 mobile device 640 to a camera on the onboarding device 610, where the user's 650 mobile device 640 may be displaying the user's ticket information with a bar code. The onboarding device 610 may the validate the PNR of the user 650 (or the ticket number of the user 650). After the onboarding device 610 validates the PNR or the ticket number, the display 660 of the onboarding device 610 can then display an menu that includes an option for “broadcast announcement onboarding” for the broadcast device 620.

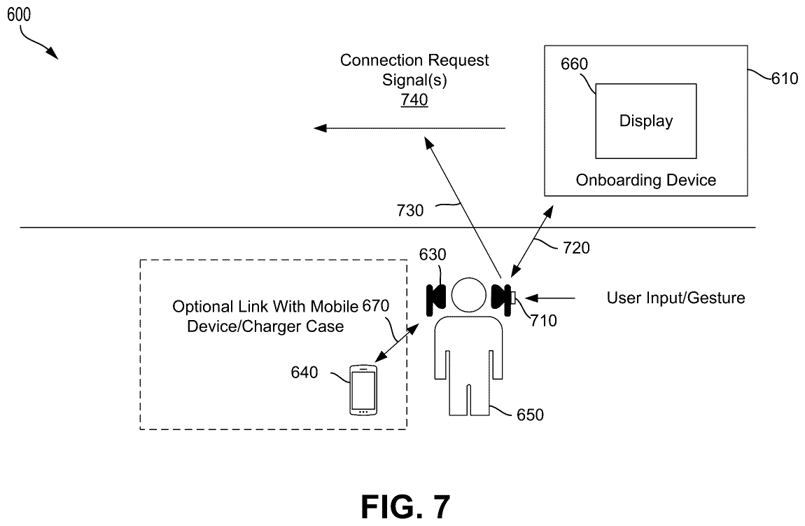

FIG. 7 is a diagram illustrating the system 600 of FIG. 6 for proximity based broadcast onboarding for audio devices, where a connection is being established between the audio device 630 associated with a user 650 and an onboarding device 610. In FIG. 7, The user 650 may then activate onboarding with the broadcasting device 620 by making a selection (e.g., selecting “broadcast announcement onboarding” displayed) on a display 660 (e.g., a touch screen) of the onboarding device 610 (e.g., to send an activation command from the user 650 to the onboarding device 610). In one or more examples, the display 660 may be a touch screen, and the user 650 can make the selection by touching the touch screen.

After the user 650 makes the selection on the display 610 of the onboarding device 660, the onboarding device 660 can start to transmit, such as via a low energy audio (LEA) link 720, one or more connection request signals 740 (e.g., connection beacons, such as a non-connectable EA), which may be in the form of non-connectable advertisements, towards the user 750. The one or more connection request signals may include an address (e.g., a Bluetooth address) for the onboarding device 610. The onboarding device 610 may then start to scan to receive one or more connection signals (e.g., first connection signals) from an audio device 630 associated with the user 650.

The user 650 can enable the audio device 630 to scan to receive the one or more connection request signals from the onboarding device 610. In one or more examples, the user 650 may enable the audio device 630 to scan by pressing a button 710 (e.g., a dedicated button, such as button 450 of FIG. 4B) on the audio device 630, or by making a selection on a display of a mobile device 640 (e.g., a mobile phone) associated with the user 650 that is in communication (e.g., via a BLE link 670) with the audio device 630. In one or more examples, when the user 650 presses the button 710 or makes a selection on the display, a scanning enabling command can be sent (e.g., transmitted) to the audio device 630.

After the user 650 enables the audio device 630 to scan, the audio device 630 may start to scan for (e.g., to receive) the one or more connection requests from the onboarding device 610 (e.g., based on receiving the scanning enabling command). The audio device 630 may then receive (e.g., via an LEA link 720) the one or more connection request signals from the onboarding device 610. After the audio device 630 receives the one or more connection request signals (e.g., including the address of the onboarding device), the audio device 630 may stop the scanning.

After the audio device 630 stops scanning, the audio device 630 may include the address of the onboarding device 610 to a list (e.g., a whitelist) stored on the audio device 630 that includes addresses of devices that the audio device 630 may connect with. The audio device 630 may then transmit (e.g., via an LEA link 720) one or more connection signals (e.g., first connection signals) directed to the address of the onboarding device 610 to establish a connection with the onboarding device 610. The onboarding device 610 may then receive (e.g., via an LEA link 720) the one or more connection signals from the audio device 630.

After the onboarding device 610 receives the one or more connection signals from the audio device 630, the onboarding device 610 can indicate (e.g., via the display of the onboarding device 610) to the user 650 that the audio device 630 is attempting to connect with the onboarding device 610. The user 650 may accept the connection with the onboarding device 610 by making a selection on the display 660 (e.g., a touch screen) of the onboarding device 610.

In one or more examples, the audio device 630 may indicate (e.g., via audio, either textual or sounds) to the user 650 that the audio device 630 is attempting to connect with the onboarding device 610. The user 650 may accept the connection with the onboarding device 610 by pressing a button 710 (e.g., a dedicated button) on the audio device 630.

In some examples, a mobile device 640 (e.g., a mobile phone or a charging device) associated with the user 650 that is in communication (e.g., via a BLE link 670) with the audio device 630 can indicate (e.g., via the display of the mobile device) to the user 650 that the audio device 630 is attempting to connect with the onboarding device 610. The user 650 may accept the connection with the onboarding device 610 by making a selection on the display (touch screen) of the mobile device 640 (e.g., to send a connection acceptance command from the user 650 to the onboarding device 610).

After the onboarding device 610 receives the acceptance from the user 650 (e.g., via the onboarding device 610, the audio device 630, and/or the mobile device 640) for the connection, the connection can be established between the audio device 630 and the onboarding device 610. After the connection is established (e.g., post pairing), the display 610 of the onboarding device 660 can display a list of broadcast channels available in various different languages (e.g., English, Hindi, Spanish, French, etc.) for the gate number associated with the user 650 (e.g., which can be known by the PNR). The user 650 can select on the display 660 the user's 650 desired language (e.g., English) to receive the gate announcements from the broadcast device 620.

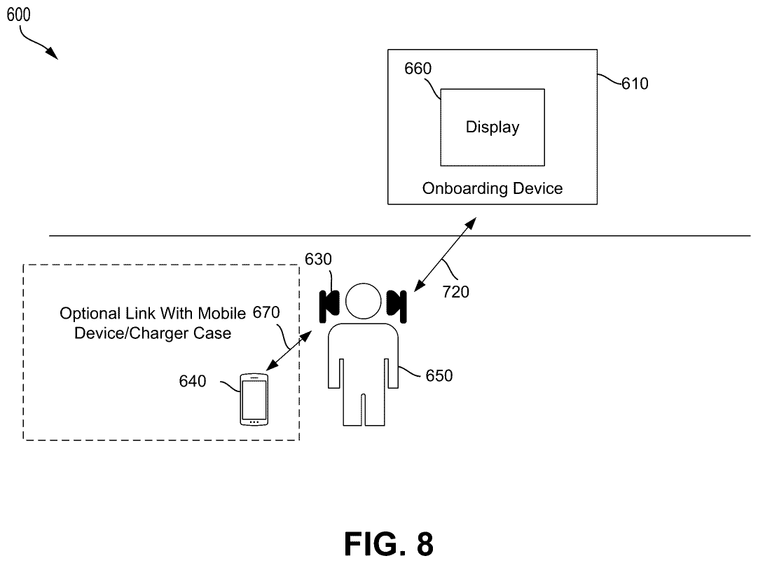

FIG. 8 is a diagram illustrating the system 600 of FIG. 6 for proximity based broadcast onboarding for audio devices, where the audio device 630 associated with the user 650 is receiving from the connected onboarding device 610 information associated with the broadcast device 620. After the onboarding device 610 receives the selected language from the user 650, the onboarding device 610 can perform a standard “add source” information with the broadcast source in English. In response, the audio device 630 can respond to the onboarding device 660 (e.g., via the LE link 720) with a broadcast receiver state notification indicating a successful “add source”. Alternatively, the display of the mobile device 640 can display a prompt from the audio device 630 that the broadcast source has been added in English. The display can prompt the user 650 with a question as to whether the user 650 wants to synchronize the audio device 630 with the broadcast device 620. The user 650 can respond “yes” via the display on the mobile device 640.

After the connection is established between the audio device 630 and the onboarding device 610, the onboarding device 610 can transmit (e.g., via an LEA link 720) one or more information signals to the audio device 630. The one or more information signals can include information (e.g., synchronization information) associated with the broadcast source. The synchronization information may include an address (e.g., Bluetooth address) for the broadcast source 620. In some cases, the one or more information signals can include information (e.g., synchronization information) associated with multiple broadcast sources, such as addresses (e.g., Bluetooth addresses) of the broadcast sources. The information (e.g., synchronization information) associated with multiple broadcast sources can allow the user (or the audio device 630) to select a broadcast source from the multiple broadcast sources. Optionally, the onboarding device 610 can transmit (e.g., via an LEA link 720) one or more encryption information signals to the audio device 630. The one or more encryption information signals may include an encryption key for the audio device 630 to use to decrypt signals received from the broadcast source 620.

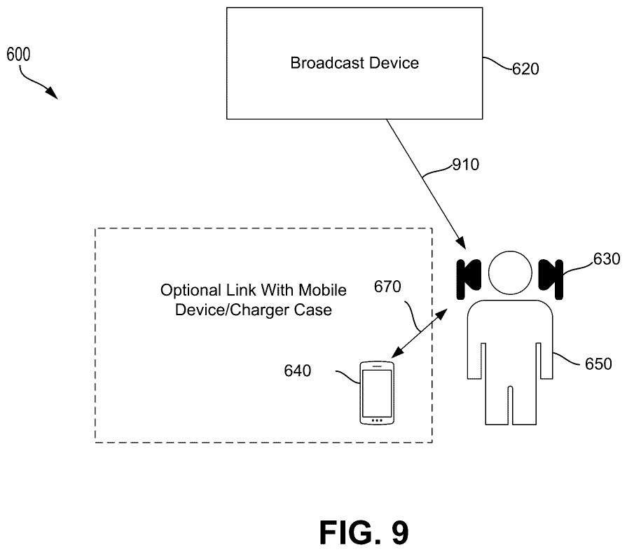

FIG. 9 is a diagram illustrating the system 600 of FIG. 6 for proximity based broadcast onboarding for audio devices, where the audio device 630 associated with the user 650 is receiving broadcast information from the connected broadcast device 620. After the audio device 630 receives the one or more information signals from the onboarding device 610, the audio device 630 can disconnect from the onboarding device 610. After the audio device 630 disconnects from the onboarding device 610, the audio device 630 can transmit, based on the information (e.g., address of the broadcast device), one or more connection signals (e.g., second connection signals) to the broadcast device 620 to establish a connection with (e.g., latch onto) the broadcast device 620. After the audio device 630 establishes a connection (e.g., via BLE link 910) with the broadcast device 620, the audio device 630 can receive one or more broadcast signals (e.g., including flight information, business related information, tour information, and/or instructional information) from the broadcast device 620 in English.

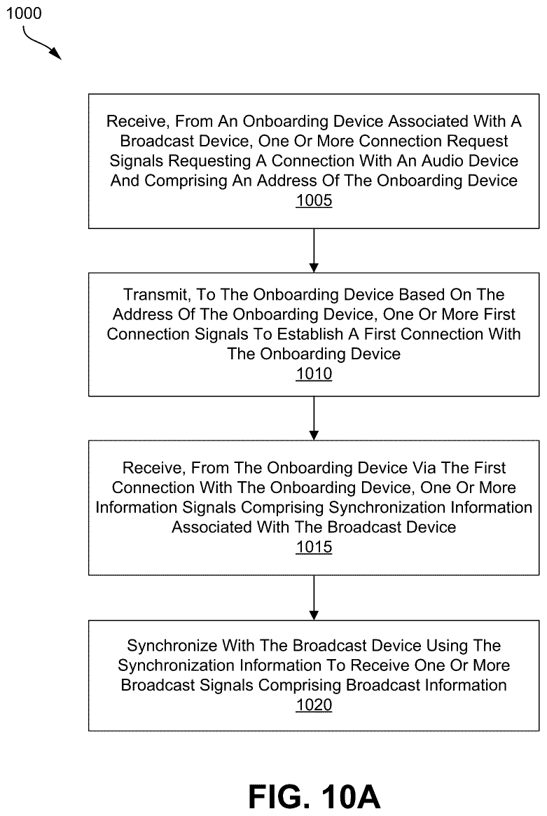

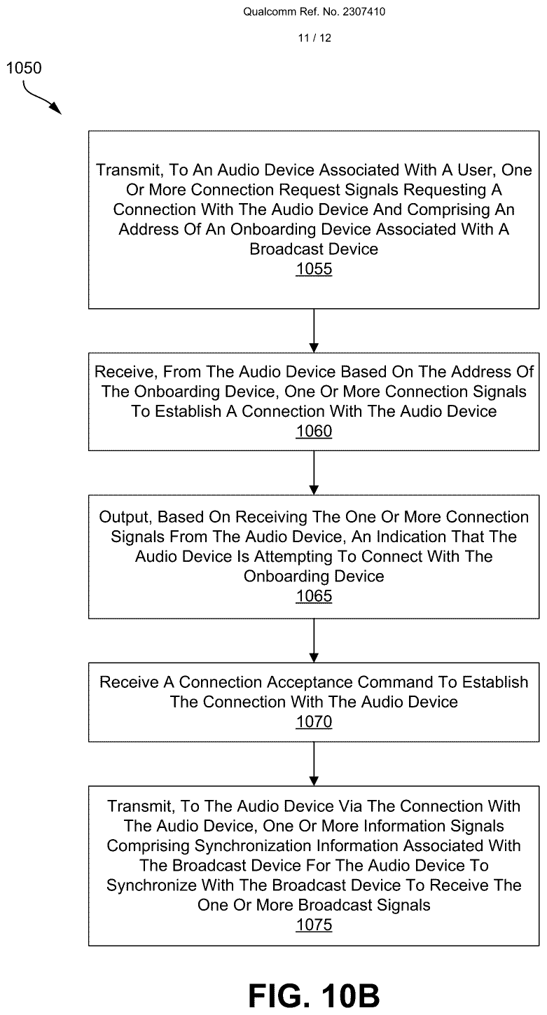

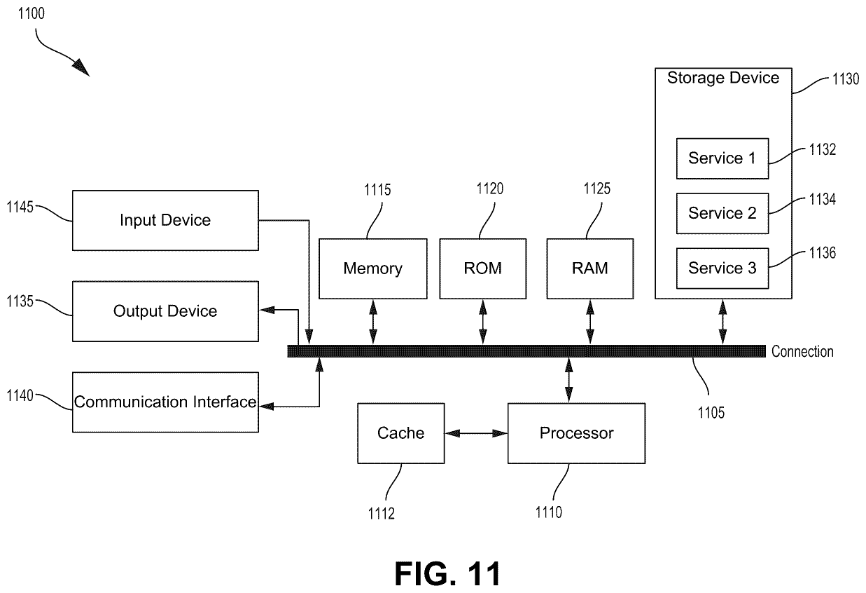

FIG. 10A is a flow chart illustrating an example of a process 1000 for proximity based broadcast onboarding for audio devices. The process 1000 can be performed by a device (e.g., wireless audio device 200 of FIG. 2, audio devices 330 of FIG. 3, HMD 410 of FIGS. 4A and 4B, audio device 520 of FIG. 5, audio device 630 of FIGS. 6, 7, 8, and 9, or other audio device) or by a component or system (e.g., a chipset, one or more processors such as one or more CPUs, DSPs, GPUs, NPUs, etc., or other component or system) of the device. In some examples, the audio device can include or be earbuds, an audio headset, a wearable device, a head-mounted display (HMD), or other type of device. The operations of the process 1000 may be implemented as software components that are executed and run on one or more processors (e.g., processor 1110 of FIG. 11 or other processor(s)). Further, the transmission and reception of signals by the device in the process 1000 may be enabled, for example, by one or more antennas and/or one or more transceivers (e.g., wireless transceiver(s)).

At block 1005, the device (or component thereof) can receive, from an onboarding device associated with a broadcast device, one or more connection request signals (e.g., one or more non-connectable advertisements) requesting a connection with the audio device and including an address (e.g., a Bluetooth address or other type of address) of the onboarding device. In some aspects, the device (or component thereof) can receive a scanning enabling command based on at least one of the user pressing a button on the audio device or the user making a selection on a display of a mobile device associated with the user and in connection with the audio device. In some cases, the device (or component thereof) can scan for the one or more connection request signals based on the audio device receiving the scanning enabling command. In some aspects, the device (or component thereof) can store the address (or cause the address to be stored in memory) of the onboarding device in a list including a listing of approved devices for establishing a connection with the audio device.

At block 1010, the device (or component thereof) can transmit (or output for transmission), to the onboarding device based on the address of the onboarding device, one or more first connection signals to establish a first connection with the onboarding device.

At block 1015, the device (or component thereof) can receive, from the onboarding device via the first connection with the onboarding device, one or more information signals including synchronization information associated with the broadcast device. In some aspects, the device (or component thereof) can receive, from the onboarding device via the first connection, information signals including synchronization information associated with a plurality of broadcast devices. In some cases, the device (or component thereof) can select the broadcast device from the plurality of broadcast devices. In some examples, the device (or component thereof) can disconnect the first connection with the onboarding device (e.g., after receiving the information signals). In some aspects, the synchronization information associated with the broadcast device includes an address of the broadcast device (e.g., a Bluetooth address or other type of address).

At block 1020, the device (or component thereof) can synchronize with the broadcast device using the synchronization information to receive one or more broadcast signals including broadcast information. For instance, the broadcast information may include flight information, business related information, tour information, instructional information, any combination thereof, and/or other information.

In some aspects, the device (or component thereof) can receive, from the onboarding device via the first connection, one or more encryption information signals including an encryption key for decrypting the one or more broadcast signals from the broadcast device.

FIG. 10B is a flow chart illustrating an example of a process 1050 for proximity based broadcast onboarding for audio devices. The process 1050 can be performed by a device (e.g., onboarding device 530 of FIG. 5, onboarding device 610 of FIG. 6, FIG. 7, and FIG. 8, or other onboarding device) or by a component or system (e.g., a chipset, one or more processors such as one or more CPUs, DSPs, GPUs, NPUs, etc., or other component or system) of the device. The operations of the process 1050 may be implemented as software components that are executed and run on one or more processors (e.g., processor 1110 of FIG. 11 or other processor(s)). Further, the transmission and reception of signals by the device in the process 1050 may be enabled, for example, by one or more antennas and/or one or more transceivers (e.g., wireless transceiver(s)).

At block 1055, the device (or component thereof) can transmit (or output for transmission), to an audio device associated with a user, one or more connection request signals requesting a connection with the audio device and including an address of the onboarding device. The device (or component thereof) can transmit the one or more connection request signals based on receiving an activation command requesting to receive one or more broadcast signals from a broadcast device associated with the onboarding device. In some examples, the audio device can include or be earbuds, an audio headset, a wearable device, a head-mounted display (HMD), or other type of device. In some aspects, the device (or component thereof) can receive the activation command based on user input indicating a selection of a broadcast option via the onboarding device.

At block 1060, the device (or component thereof) can receive, from the audio device based on the address of the onboarding device, one or more connection signals to establish a connection with the audio device.

At block 1065, the device (or component thereof) can output, based on receiving the one or more connection signals from the audio device, an indication that the audio device is attempting to connect with the onboarding device.

At block 1070, the device (or component thereof) can receive a connection acceptance command to establish the connection with the audio device. In some aspects, the device (or component thereof) can receive the connection acceptance command based on the user making a selection on a display of the onboarding device, the user pressing a button on the audio device, the user making a selection on a display of a mobile device associated with the user and in connection with the audio device, any combination thereof, and/or other action.

At block 1075, the device (or component thereof) can transmit (or output for transmission), to the audio device via the connection with the audio device, one or more information signals including synchronization information associated with the broadcast device for the audio device to synchronize with the broadcast device to receive the one or more broadcast signals. In some aspects, the device (or component thereof) can transmit (or output for transmission), to the audio device via the connection, information signals including synchronization information associated with a plurality of broadcast devices. In some cases, the synchronization information includes an address of the broadcast device (e.g., a Bluetooth address or other type of address).

In some cases, the device (or component thereof) can transmit (or output for transmission), to the audio device via the connection with the audio device, one or more encryption information signals including an encryption key for decrypting the one or more broadcast signals from the broadcast device.

In some aspects, the devices configured to perform the operations of process 1000 and the process 1050, respectively, may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 and the process 1050 are illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1000, the process 1050, and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 11 is a block diagram illustrating an example of a computing system 1100, which may be employed for proximity based broadcast onboarding for audio devices. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100.

Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more range sensors (e.g., LIDAR sensors, laser range finders, RF radars, ultrasonic sensors, and infrared (IR) sensors) configured to collect data and provide measurements to processor 1110, whereby processor 1110 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smartphones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of”′ a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An audio device associated with a user for wireless communications, the audio device comprising: at least one memory; and at least one processor coupled to the at least one memory and configured to: receive, from an onboarding device associated with a broadcast device, one or more connection request signals requesting a connection with the audio device and comprising an address of the onboarding device; output, for transmission to the onboarding device based on the address of the onboarding device, one or more first connection signals to establish a first connection with the onboarding device; receive, from the onboarding device via the first connection with the onboarding device, one or more information signals comprising synchronization information associated with the broadcast device; and synchronize with the broadcast device using the synchronization information to receive one or more broadcast signals comprising broadcast information.

Aspect 2. The audio device of Aspect 1, wherein the at least one processor is configured to receive a scanning enabling command based on at least one of the user pressing a button on the audio device or the user making a selection on a display of a mobile device associated with the user and in connection with the audio device.

Aspect 3. The audio device of Aspect 2, wherein the at least one processor is configured to scan for the one or more connection request signals based on the audio device receiving the scanning enabling command.

Aspect 4. The audio device of any one of Aspects 1 to 3, wherein the at least one processor is configured to cause the address of the onboarding device to be stored in a list comprising a listing of approved devices for establishing a connection with the audio device.

Aspect 5. The audio device of any one of Aspects 1 to 4, wherein the at least one processor is configured to receive, from the onboarding device via the first connection, one or more encryption information signals comprising an encryption key for decrypting the one or more broadcast signals from the broadcast device.

Aspect 6. The audio device of any one of Aspects 1 to 5 wherein the at least one processor is configured to receive, from the onboarding device via the first connection, information signals comprising synchronization information associated with a plurality of broadcast devices.

Aspect 7. The audio device of Aspect 6, wherein the at least one processor is configured to select the broadcast device from the plurality of broadcast devices.

Aspect 8. The audio device of any one of Aspects 1 to 7, wherein the at least one processor is configured to disconnect the first connection with the onboarding device.

Aspect 9. The audio device of any one of Aspects 1 to 8, wherein the address of the onboarding device is a Bluetooth address.

Aspect 10. The audio device of any one of Aspects 1 to 9, wherein the one or more connection request signals are non-connectable advertisements.

Aspect 11. The audio device of any one of Aspects 1 to 10, wherein the broadcast information comprises at least one of flight information, business related information, tour information, or instructional information.

Aspect 12. The audio device of any one of Aspects 1 to 11, wherein the audio device is one of earbuds, an audio headset, a wearable device, or a head-mounted display (HMD).

Aspect 13. The audio device of any one of Aspects 1 to 12, wherein the synchronization information associated with the broadcast device comprises an address of the broadcast device.

Aspect 14. An onboarding device for wireless communications, the onboarding device comprising: at least one memory; and at least one processor coupled to the at least one memory and configured to: output, for transmission to an audio device associated with a user based on receiving an activation command requesting to receive one or more broadcast signals from a broadcast device associated with the onboarding device, one or more connection request signals requesting a connection with the audio device and comprising an address of the onboarding device; receive, from the audio device based on the address of the onboarding device, one or more connection signals to establish a connection with the audio device; output, based on receiving the one or more connection signals from the audio device, an indication that the audio device is attempting to connect with the onboarding device; receive a connection acceptance command to establish the connection with the audio device; and output, for transmission to the audio device via the connection with the audio device, one or more information signals comprising synchronization information associated with the broadcast device for the audio device to synchronize with the broadcast device to receive the one or more broadcast signals.

Aspect 15. The onboarding device of Aspect 14, wherein the at least one processor is configured to receive the activation command based on user input indicating a selection of a broadcast option via the onboarding device.

Aspect 16. The onboarding device of any one of Aspects 14 or 15, wherein the at least one processor is configured to receive the connection acceptance command based on at least one of the user making a selection on a display of the onboarding device, the user pressing a button on the audio device, or the user making a selection on a display of a mobile device associated with the user and in connection with the audio device.

Aspect 17. The onboarding device of any one of Aspects 14 to 16, wherein the at least one processor is configured to output, for transmission to the audio device via the connection with the audio device, one or more encryption information signals comprising an encryption key for decrypting the one or more broadcast signals from the broadcast device.

Aspect 18. The onboarding device of any one of Aspects 14 to 17, wherein the at least one processor is configured to output, for transmission to the audio device via the connection, information signals comprising synchronization information associated with a plurality of broadcast devices.

Aspect 19. The onboarding device of any one of Aspects 14 to 18, wherein the synchronization information comprises an address of the broadcast device.

Aspect 20. A method for wireless communications at an audio device associated with a user, the method comprising: receiving, by the audio device from an onboarding device associated with a broadcast device, one or more connection request signals requesting a connection with the audio device and comprising an address of the onboarding device; transmitting, by the audio device to the onboarding device based on the address of the onboarding device, one or more first connection signals to establish a first connection with the onboarding device; receiving, by the audio device from the onboarding device via the first connection with the onboarding device, one or more information signals comprising synchronization information associated with the broadcast device; and synchronizing, by the audio device, with the broadcast device using the synchronization information to receive one or more broadcast signals comprising broadcast information.

Aspect 21. The method of Aspect 20, further comprising receiving, by the audio device, a scanning enabling command based on at least one of the user pressing a button on the audio device or the user making a selection on a display of a mobile device associated with the user and in connection with the audio device.

Aspect 22. The method of Aspect 21, further comprising scanning, by the audio device, for the one or more connection request signals based on the audio device receiving the scanning enabling command.

Aspect 23. The method of any one of Aspects 20 to 22, further comprising storing, by the audio device, the address of the onboarding device in a list comprising a listing of approved devices for establishing a connection with the audio device.

Aspect 24. The method of any one of Aspects 20 to 23, further comprising receiving, by the audio device from the onboarding device via the first connection, one or more encryption information signals comprising an encryption key for decrypting the one or more broadcast signals from the broadcast device.

Aspect 25. The method of any one of Aspects 20 to 24, further comprising receiving, by the audio device from the onboarding device via the first connection, information signals comprising synchronization information associated with a plurality of broadcast devices.

Aspect 26. The method of Aspect 25, further comprising selecting, by the audio device, the broadcast device from the plurality of broadcast devices.

Aspect 27. The method of any one of Aspects 20 to 26, further comprising disconnecting, by the audio device, the first connection with the onboarding device.

Aspect 28. The method of any one of Aspects 20 to 27, wherein the address of the onboarding device is a Bluetooth address.

Aspect 29. The method of any one of Aspects 20 to 28, wherein the one or more connection request signals are non-connectable advertisements.

Aspect 30. The method of any one of Aspects 20 to 29, wherein the broadcast information comprises at least one of flight information, business related information, tour information, or instructional information.

Aspect 31. The method of any one of Aspects 20 to 30, wherein the audio device is one of earbuds, an audio headset, a wearable device, or a head-mounted display (HMD).

Aspect 32. The method of any one of Aspects 20 to 31, wherein the synchronization information associated with the broadcast device comprises an address of the broadcast device.

Aspect 33. A method for wireless communications at an onboarding device, the method comprising: transmitting, by the onboarding device associated with a broadcast device to an audio device associated with a user based on receiving an activation command requesting to receive one or more broadcast signals from the broadcast device, one or more connection request signals requesting a connection with the audio device and comprising an address of the onboarding device; receiving, by the onboarding device from the audio device based on the address of the onboarding device, one or more connection signals to establish a connection with the audio device; outputting, by the onboarding device based on receiving the one or more connection signals from the audio device, an indication that the audio device is attempting to connect with the onboarding device; receiving, by the onboarding device, a connection acceptance command to establish the connection with the audio device; and transmitting, by the onboarding device to the audio device via the connection with the audio device, one or more information signals comprising synchronization information associated with the broadcast device for the audio device to synchronize with the broadcast device to receive the one or more broadcast signals.

Aspect 34. The method of Aspect 33, further comprising receiving, by the onboarding device, the activation command based on user input indicating a selection of a broadcast option via the onboarding device.

Aspect 35. The method of any one of Aspects 33 or 34, wherein the connection acceptance command is received based on at least one of the user making a selection on a display of the onboarding device, the user pressing a button on the audio device, or the user making a selection on a display of a mobile device associated with the user and in connection with the audio device.

Aspect 36. The method of any one of Aspects 33 to 35, further comprising transmitting, by the onboarding device to the audio device via the connection with the audio device, one or more encryption information signals comprising an encryption key for decrypting the one or more broadcast signals from the broadcast device.

Aspect 37. The method of any one of Aspects 33 to 36, further comprising transmitting, by the onboarding device to the audio device via the connection, information signals comprising synchronization information associated with a plurality of broadcast devices.

Aspect 38. The method of any one of Aspects 33 to 37, wherein the synchronization information comprises an address of the broadcast device.

Aspect 39. A non-transitory computer-readable medium having stored thereon instructions that, when executed by one or more processors, cause the one or more processors to perform operations according to any of Aspects 20 to 32.

Aspect 40. An apparatus including one or more means for performing operations according to any of Aspects 20 to 32.

Aspect 41. A non-transitory computer-readable medium having stored thereon instructions that, when executed by one or more processors, cause the one or more processors to perform operations according to any of Aspects 33 to 38.

Aspect 42. An apparatus including one or more means for performing operations according to any of Aspects 33 to 38.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An audio device associated with a user for wireless communications, the audio device comprising:
at least one memory; and
at least one processor coupled to the at least one memory and configured to:
receive, from an onboarding device associated with a broadcast device, one or more connection request signals requesting a connection with the audio device and comprising an address of the onboarding device;
output, for transmission to the onboarding device based on the address of the onboarding device, one or more first connection signals to establish a first connection with the onboarding device;
receive, from the onboarding device via the first connection with the onboarding device, one or more information signals comprising synchronization information associated with the broadcast device; and
synchronize with the broadcast device using the synchronization information to receive one or more broadcast signals comprising broadcast information.

2. The audio device of claim 1, wherein the at least one processor is configured to receive a scanning enabling command based on at least one of the user pressing a button on the audio device or the user making a selection on a display of a mobile device associated with the user and in connection with the audio device.

3. The audio device of claim 2, wherein the at least one processor is configured to scan for the one or more connection request signals based on the audio device receiving the scanning enabling command.

4. The audio device of claim 1, wherein the at least one processor is configured to cause the address of the onboarding device to be stored in a list comprising a listing of approved devices for establishing a connection with the audio device.

5. The audio device of claim 1, wherein the at least one processor is configured to receive, from the onboarding device via the first connection, one or more encryption information signals comprising an encryption key for decrypting the one or more broadcast signals from the broadcast device.

6. The audio device of claim 1, wherein the at least one processor is configured to receive, from the onboarding device via the first connection, information signals comprising synchronization information associated with a plurality of broadcast devices.

7. The audio device of claim 6, wherein the at least one processor is configured to select the broadcast device from the plurality of broadcast devices.

8. The audio device of claim 1, wherein the at least one processor is configured to disconnect the first connection with the onboarding device.

9. The audio device of claim 1, wherein the address of the onboarding device is a Bluetooth address.

10. The audio device of claim 1, wherein the one or more connection request signals are non-connectable advertisements.

11. The audio device of claim 1, wherein the audio device is one of earbuds, an audio headset, a wearable device, or a head-mounted display (HMD).

12. The audio device of claim 1, wherein the synchronization information associated with the broadcast device comprises an address of the broadcast device.

13. An onboarding device for wireless communications, the onboarding device comprising:
at least one memory; and
at least one processor coupled to the at least one memory and configured to:
output, for transmission to an audio device associated with a user based on receiving an activation command requesting to receive one or more broadcast signals from a broadcast device associated with the onboarding device, one or more connection request signals requesting a connection with the audio device and comprising an address of the onboarding device;
receive, from the audio device based on the address of the onboarding device, one or more connection signals to establish a connection with the audio device;
output, based on receiving the one or more connection signals from the audio device, an indication that the audio device is attempting to connect with the onboarding device;
receive a connection acceptance command to establish the connection with the audio device; and
output, for transmission to the audio device via the connection with the audio device, one or more information signals comprising synchronization information associated with the broadcast device for the audio device to synchronize with the broadcast device to receive the one or more broadcast signals.

14. The onboarding device of claim 13, wherein the at least one processor is configured to receive the activation command based on user input indicating a selection of a broadcast option via the onboarding device.

15. The onboarding device of claim 13, wherein the at least one processor is configured to receive the connection acceptance command based on at least one of the user making a selection on a display of the onboarding device, the user pressing a button on the audio device, or the user making a selection on a display of a mobile device associated with the user and in connection with the audio device.

16. The onboarding device of claim 13, wherein the at least one processor is configured to output, for transmission to the audio device via the connection with the audio device, one or more encryption information signals comprising an encryption key for decrypting the one or more broadcast signals from the broadcast device.

17. The onboarding device of claim 13, wherein the at least one processor is configured to output, for transmission to the audio device via the connection, information signals comprising synchronization information associated with a plurality of broadcast devices.

18. The onboarding device of claim 13, wherein the synchronization information comprises an address of the broadcast device.

19. A method for wireless communications at an audio device associated with a user, the method comprising:
receiving, by the audio device from an onboarding device associated with a broadcast device, one or more connection request signals requesting a connection with the audio device and comprising an address of the onboarding device;
transmitting, by the audio device to the onboarding device based on the address of the onboarding device, one or more first connection signals to establish a first connection with the onboarding device;
receiving, by the audio device from the onboarding device via the first connection with the onboarding device, one or more information signals comprising synchronization information associated with the broadcast device; and
synchronizing, by the audio device, with the broadcast device using the synchronization information to receive one or more broadcast signals comprising broadcast information.

20. The method of claim 19, further comprising receiving, by the audio device, a scanning enabling command based on at least one of the user pressing a button on the audio device or the user making a selection on a display of a mobile device associated with the user and in connection with the audio device.

21. The method of claim 20, further comprising scanning, by the audio device, for the one or more connection request signals based on the audio device receiving the scanning enabling command.

22. The method of claim 19, further comprising storing, by the audio device, the address of the onboarding device in a list comprising a listing of approved devices for establishing a connection with the audio device.

23. The method of claim 19, further comprising receiving, by the audio device from the onboarding device via the first connection, one or more encryption information signals comprising an encryption key for decrypting the one or more broadcast signals from the broadcast device.

24. The method of claim 19, further comprising receiving, by the audio device from the onboarding device via the first connection, information signals comprising synchronization information associated with a plurality of broadcast devices.

25. The method of claim 24, further comprising selecting, by the audio device, the broadcast device from the plurality of broadcast devices.

26. The method of claim 19, wherein the one or more connection request signals are non-connectable advertisements.

27. The method of claim 19, wherein the synchronization information associated with the broadcast device comprises an address of the broadcast device.

28. A method for wireless communications at an onboarding device, the method comprising:
transmitting, by the onboarding device associated with a broadcast device to an audio device associated with a user based on receiving an activation command requesting to receive one or more broadcast signals from the broadcast device, one or more connection request signals requesting a connection with the audio device and comprising an address of the onboarding device;
receiving, by the onboarding device from the audio device based on the address of the onboarding device, one or more connection signals to establish a connection with the audio device;
outputting, by the onboarding device based on receiving the one or more connection signals from the audio device, an indication that the audio device is attempting to connect with the onboarding device;
receiving, by the onboarding device, a connection acceptance command to establish the connection with the audio device; and
transmitting, by the onboarding device to the audio device via the connection with the audio device, one or more information signals comprising synchronization information associated with the broadcast device for the audio device to synchronize with the broadcast device to receive the one or more broadcast signals.

29. The method of claim 28, further comprising receiving, by the onboarding device, the activation command based on user input indicating a selection of a broadcast option via the onboarding device.

30. The method of claim 28, wherein the connection acceptance command is received based on at least one of the user making a selection on a display of the onboarding device, the user pressing a button on the audio device, or the user making a selection on a display of a mobile device associated with the user and in connection with the audio device.
